(19) United States
(12) Patent Application Publication
(10) Pub. No.: US 2021/0217395 A1
(43) Pub. Date: Jul. 15, 2021

(54) CONTACT TRANSDUCER FOR MUSICAL INSTRUMENTS WITH SOUNDBOARD

(71) Applicant: ROBERTO GARDIN, PORTOFERRAIO (IT)

(72) Inventor: ROBERTO GARDIN, PORTOFERRAIO (IT)

(21) Appl. No.: 16/967,496

(22) PCT Filed: Jan. 23, 2019
(86) PCT No.: PCT/IT19/50017

§ 371 Date: Aug. 5, 2020

(30) Foreign Application Priority Data
Feb. 5, 2018 (IT) 102018000001968

(51) Int. Cl. G10H 3/14; G10H 3/18

(52) U.S. Cl. CPC G10H 3/146; G10H 2220/461; G10H 3/186; G10H 3/143

(57) ABSTRACT

Contact transducer for musical instruments with soundboard, comprising:
vibrating element, consisting of an air core coil made of enameled copper wire, suitable to be placed in contact with the soundboard of any musical instrument, and able to vibrate according to said soundboard;
magnetic field generator, consisting of a permanent magnet, preferably made of neodymium, suitable to transform the vibrations of the vibrating element induced by the soundboard in electric signals, according to the principle of electromagnetic induction;
sound-insulating separator made of elastic material, on which the magnetic field generator is fixed, keeping it firmly and close to the vibrating element, and isolating it from the vibrations of the soundboard;
electric cable connected to the ends of the copper wire of the vibrating element with at least one connector suitable to transfer the electrical signal generated to at least one sound amplification device.

### FIELD OF THE INVENTION

The present invention operates in the field of music and in particular of sound amplification instruments. Even more in detail, the transducer in question is applicable to any type of acoustic musical instrument.

### PRIOR ART

A transducer for acoustic musical instruments is notoriously a device for detecting the vibrations produced by the performer and transforming them into an electrical signal. Taking as an example the classical guitar, the musician, pinching the strings, causes the vibration which are transferred to the soundboard of the instrument. The vibration-sensitive transducer is positioned precisely on the soundboard.

The electrical signal obtained is then sent to an amplifier and then to the speakers, which reproduce the vibrations with a sound amplitude greater than the initial signal.

Currently, the commonly used transducers, dedicated to a “live” use, in which an amplification is therefore essential, they are mainly: microphones, in all possible variants, and piezoelectric pressure sensors that are positioned (in the case of the classical guitar classical) between the “bridge” and the “saddle”.

In addition to these, other less common systems could also be mentioned, but they do not represent qualitatively superior solutions compared to the systems already mentioned.

The use of any type of microphone as a transducer for sound amplification presents as a problem called “feedback effect”. The microphone, in fact, in addition to the sound of the instrument, it also captures the same sound which is amplified by the speakers to which it is sent, thus causing the re-entry into the microphone of the already amplified sound inducing noises and whistles unrelated to the initial sound and also changing the quality of the latter. These disadvantages do not consider the possibility that other instruments are played at the same time; their sound will be also captured, further complicating the acoustic resumption of the instrument.

These are the causes of a series of compromises that are difficult to control, in a poor possibility of obtaining a satisfactory volume of sound and, in any case, having a degradation of the sound quality.

The other method, based on the piezoelectric crystal, it is used for example in the patent JP2015029270, and it has a good resistance to feedback, but the sound quality is not in any way comparable with the one that the instrument could potentially offer. This is due to the fact that the electrical signal comes from a compression that does not correspond to what the human ear perceives. Repeating the example of the classical guitar, the compression is due to the “saddle” that presses against the “base of the bridge”, while the human ear perceives the vibration of the instrument's soundboard. This causes a difficulty for the performer to control the sound because when he is trying to produce a certain result he is hearing a different one result.

### SUMMARY OF THE INVENTION

According to the present invention, a transducer for acoustic musical instruments which effectively solves the above said problems is provided.

Advantageously, the transducer in question can be used with the same quality of performance for plucked string instruments, bowed instruments, pianos and other acoustic keyboard instruments, preferably for classical guitar.

It has a very reduced weight and dimensions, so as to be advantageously installable both externally and internally to the musical instrument. More in detail its weight is between 1 g and 50 g, preferably 2.5 g and its dimensions are between 4 mm×12 mm×4 mm in height and 70 mm×80 mm×50 mm in height, preferably 10 mm×20 mm×13 mm in height.

The transducer of the present invention comprises:
a vibrating element, consisting of an air core coil made of enameled copper wire, suitable to be placed in contact with the soundboard of any musical instrument and able to vibrate in harmony with said soundboard; said coil consists of enameled copper wire windings with a diameter comprised between 0.03 mm and 0.5 mm, preferably 0.05 mm; with a number of windings, preferably in ring-shape, varying between 10 and 10.000, preferably 500; said coil, in the preferred embodiment, has a thickness of 2 mm, an outer diameter of 6 mm and an inner diameter of 4 mm.
A magnetic field generator, consisting of a permanent magnet, preferably made of neodymium, which is able to create a magnetic field in proximity of the vibrating element, allowing the coil of the vibrating element to transform the vibrations received from the soundboard into an electrical signal; the magnet is cylindrical and has a diameter comprised between 1 mm and 20 mm, preferably 4 mm, and a height varying between 1 mm and 10 mm, preferably 3 mm.
A sound-insulating separator, suitable to act as a support on which the magnetic field generator is arranged and to keep the magnetic field generator in a stable position close to the vibrating element. The sound-insulating separator is advantageously made of silicone or any other material having elastic properties suitable to acoustically isolate said magnetic field generator from said vibrating element.
An electric cable, preferably a shielded bipolar electric cable whose two electrical contacts are both connected to the ends of the copper wire of the coil of said vibrating element, said electric cable is adapted to connect said vibrating element to at least one sound amplification device through a connector.

Advantageously, said vibrating element and said magnetic field generator can be reciprocally exchanged in position. This because their function depends on their installation position in a magnetic field and with respect to the soundboard. In other words, the magnet of the magnetic field generator can be arranged in contact with the soundboard acting as a vibrating element as well as a magnetic field generator, and the coil of the vibrating element can be fixed to the sound-insulating separator acting as electrical signal transformator of the vibrations of the magnet thanks to the magnetic field, according to the principles of electromagnetic induction.

In the preferred embodiment, the transducer of the present invention is placed on a base suitable to be arranged in a stable and preferably reversible manner. Optionally and preferably it has an upper casing, which is necessary in case of external installation on the musical instrument, and which is optional in case of internal installation on the musical instrument, forming a volume that comprises all the components of said transducer. Advantageously, in order to ensure the correct operation of the transducer, the inner surface of the base must be placed in contact with the vibrating element, while the external surface of the base must be positioned in contact with the soundboard of the musical instrument.

Preferably and advantageously, the outer surface of said base is provided with a connection element made of a stable or reversible adhesive type, suitable to allow a stable connection with the soundboard of the musical instrument.

The advantages offered by the present invention are evident in the light of the above description and will be even clearer thanks to the attached figures and the related detailed description.

### DESCRIPTION OF THE FIGURES

The invention will hereinafter be described in at least one preferred embodiment for explanatory and non-limiting purposes with the aid of the accompanying figures, in which:

FIG. 1 shows the external appearance of the transducer 1 of the present invention with the upper casing shown in its parallelepiped form with the cable 2 and the connector 2′ externally protruding.

FIG. 2 shows an axonometric exploded view of the transducer 1 in which, in addition to the cable 2 and the connector 2′, the internal devices can be seen. Said transducer 1 consists of a base 4′ and an upper casing 4, which are hooked together creating a closed volume. Externally to the base 4′ a connection element 3 is provided which allows adhesion to the musical instrument. On the inner surface 4″ of the base 4′ it can be seen the vibrating element 5 which receives the magnetic field from the magnetic field generator 6 arranged on the sound-insulating separator 7.

FIG. 3 illustrates a possible positioning of the transducer 1 in question on the outer surface of a musical instrument 100, in this case, a classical guitar.

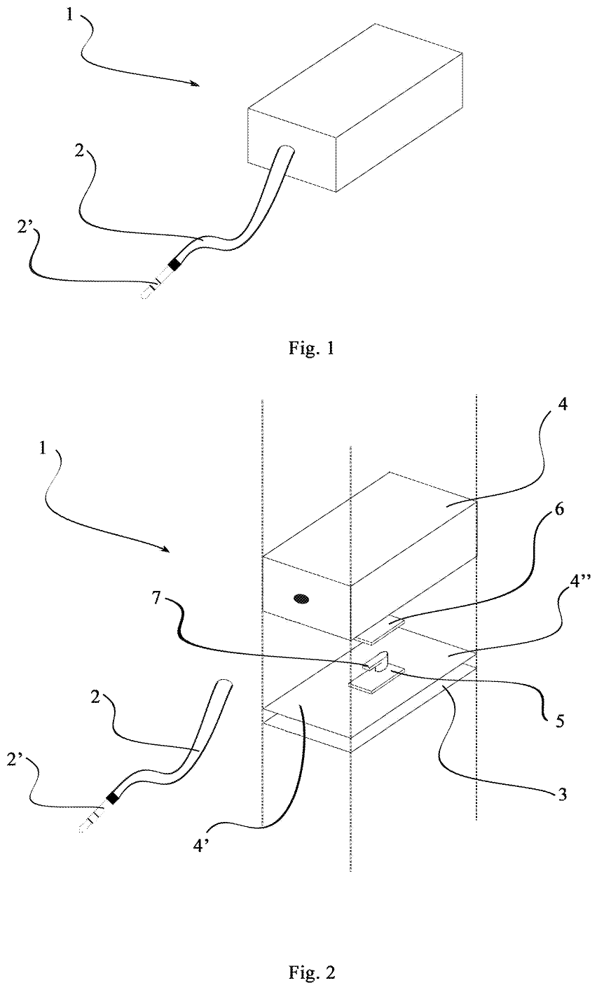

### DETAILED DESCRIPTION OF THE INVENTION

The present invention will now be illustrated purely by way of non-limiting example, using the figures which illustrate some embodiments in relation to the present inventive concept.

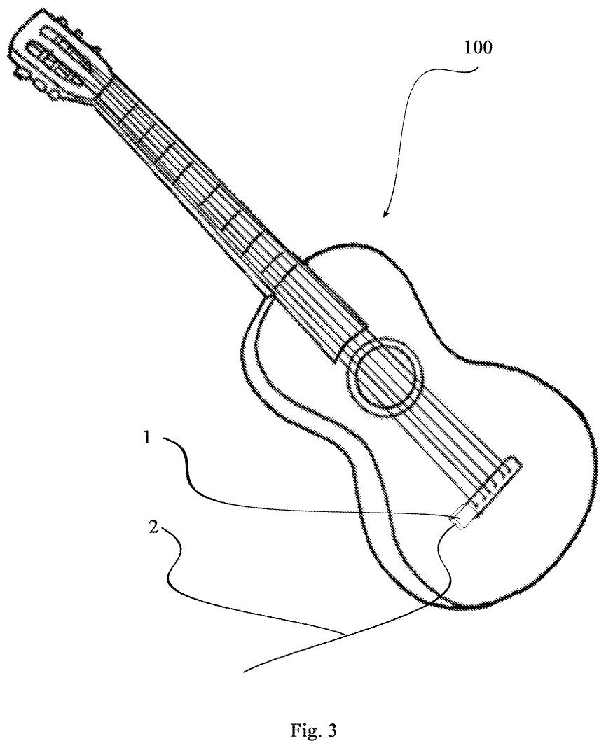

With reference to FIG. 3 it is shown the size of a transducer 1 according to the present invention which has been connected to the soundboard of a classical guitar 100.

The adhesion of the transducer 1 outside the instrument 100 does not limit other possible installations inside the guitar or other plucked stringed instruments, arcs, pianos and other acoustic keyboard instruments, harps.

The small size and weight of the object are the characteristic that makes it so versatile. The transducer 1, in fact, in its preferred embodiment, can be inscribed in a parallelepiped with dimensions equal to 10 mm×20 mm×13 mm in height and has a weight of about 2.5 g.

To be applicable, in a reversible manner, to any musical instrument 100 provided with a soundboard, the transducer 1 is included in a parallelepiped-shaped structure consisting of a base 4′ and a casing 4 adapted to connect with each other in a stable and preferably reversible manner. As it can be seen in FIG. 2, the inner surface 4″ of said base 4′ it is placed in contact with the vibrating element 5 described in detail below. The external surface of the base 4′, on the other hand, it is the one that must be placed in contact with the soundboard of the guitar 100 and for this reason it is provided with an adhesive-type connection element 3.

Inside the casing 4, the transducer 1 comprises said vibrating element 5, a magnetic field generator 6, and a sound-insulating separator 7 interposed between the vibrating element 5 and the magnetic field generator 6.

More specifically, the vibrating element 5 is constituted by an air core coil made of enameled copper wire, preferably arranged in a ring shape. Said vibrating element is suitable to be placed in contact with the soundboard of any musical instrument 100 and adapted to vibrate according to the vibrations of said soundboard.

The magnetic field generator 6 is constituted by a magnet, preferably in neodymium, able to create in the proximity of the vibrating element 5 the condition necessary to transform the vibrations of the vibrating element 5 into electrical signals, according to the principle of electromagnetic induction.

It should be noted that the vibrating element 5 and the magnetic field generator 6 are two interchangeable elements in terms of positioning, their function depending on their mutual position, as well as their positioning with respect to the soundboard of the instrument 100.

The sound-insulating separator 7 is an element capable of damping the vibrations between the two elements 5-6 described above. It is preferably made of silicone and with the form shown in FIG. 2, but this does not limit other possible geometric shapes and construction material as long as the sound-insulating separator 7 maintains its acoustic insulation function unchanged. The dimensions of said sound-insulating separator make it inscribable in a parallelepiped of dimensions comprised between 5 mm×2 mm×2 mm in height, and 60 mm×45 mm×60 mm in height, preferably 16 mm×6 mm×6 mm in height.

To complete the transducer 1, a shielded bipolar electric cable 2 is provided, the two electrical contacts of the electric cable 2 are connected to the vibrating element 5 and precisely to the two ends of the enameled copper wire of the coil. At the outer end, said cable 2 is provided with a connector 2′ adapted to transfer the electrical signal generated, to at least one sound amplification device.

Finally, it is clear that modifications, additions or obvious variations that may be made by a person skilled in the art, without departing from the scope of protection provided by the appended claims, are included in the present invention.

1.-10. (canceled)

11. A contact transducer for acoustic musical instruments with a vibrating soundboard, comprising:
a vibrating element operable to be placed in contact with the soundboard of the musical instrument and adapted to vibrate in harmony with the soundboard to which it is arranged, the vibrating element including a coil of enameled copper wire having a diameter between 0.01 mm and 0.5 mm;
a magnetic field generator including a magnet operable to transform vibrations of the vibrating element near which it is positioned, in electrical signals according to the principle of electromagnetic induction, wherein a distance that separates the vibrating element and the magnetic field generator is between 0.5 mm and 4 mm and being inversely proportional to an intensity of the electrical signal;
a sound-insulating separator operable to support the magnetic field generator and to keep a predetermined distance with respect to the vibrating element unchanged and operable to acoustically isolate the magnetic field generator from the vibrations of the soundboard of the instrument; and
an electric cable operable to connect the vibrating element with at least one connector adapted to transfer the electrical signal generated to at least one sound amplification device.

12. The contact transducer for acoustic musical instruments with a vibrating soundboard according to claim 11, further comprising a casing and a base operable to connect themselves together in stable and preferably reversible manner, forming a volume that contains all the components of the transducer, an inner surface of the base being placed in contact with the vibrating element, the base being adapted to be positioned on the soundboard of the musical instrument.

13. The contact transducer (1) for acoustic musical instruments with a vibrating soundboard according to claim 12, further comprising a connection element provided at an outer surface of the base made of a stable or reversible adhesive type, the connection element being operable to allow a stable connection with the soundboard of the musical instrument.

14. The contact transducer for acoustic musical instruments with a vibrating soundboard according to claim 11, wherein the cable is a shielded bipolar electrical cable whose electrical contacts are both connected to the vibrating element.

15. A contact transducer for acoustic musical instruments with a vibrating soundboard according to claim 11, wherein the sound-insulating separator includes silicone or any other material having elastic properties operable to acoustically isolate the magnetic field generator from the vibrating element.

16. The contact transducer for acoustic musical instruments with a vibrating soundboard according to claim 11, wherein the vibrating element and the magnetic field generator are interchangeable with each other, their function exclusively depending on their mutual position and an installation position with respect to the soundboard of the musical instrument.

17. The contact transducer for acoustic musical instruments with a vibrating soundboard according to claim 11, wherein it can be installed both externally or internally to the musical instrument.

18. The contact transducer for acoustic musical instruments with a vibrating soundboard according to claim 11, wherein the sound-insulating separator can be inscribed in a parallelepiped of height dimensions between 5 mm×2 mm×2 mm and 60 mm×45 mm×60 mm.

19. The contact transducer for acoustic musical instruments with a vibrating soundboard according to claim 11, wherein it has overall height dimensions between 4 mm×12 mm×4 mm and 90 mm×90 mm×70 mm.

20. The contact transducer for acoustic musical instruments with a vibrating soundboard according to claim 11, wherein it can be used for pinched, arched, piano and other acoustic instruments with a keyboard, harps, and classical guitar.
